(19) United States
(12) Patent Application Publication
(10) Pub. No.: US 2015/0242866 A1
(43) Pub. Date: Aug. 27, 2015

(54) DETERMINATION DEVICE, DETERMINATION METHOD, AND COMPUTER-READABLE RECORDING MEDIUM

(71) Applicant: NEC Corporation, Minato-ku, Tokyo (JP)

(72) Inventors: Daishi Kato, Tokyo (JP); Satoru Ooga, Tokyo (JP); Takao Shime, Tokyo (JP)

(21) Appl. No.: 14/429,422

(22) PCT Filed: Sep. 25, 2013
(86) PCT No.: PCT/JP2013/075784

§ 371 Date: Mar. 19, 2015

(30) Foreign Application Priority Data
Sep. 27, 2012 (JP) 2012-214218

(51) Int. Cl. G06Q 30/02

(52) U.S. Cl. CPC G06Q 30/0204

(57) ABSTRACT

A determination device (10) is used. The determination device (10) includes: a product identification unit (11) that discovers, from a document published on the Internet, a particular action taken by a user on a particular product, and identifies another product that has been used in the discovered particular action and is different from the particular product; a follower identification unit (12) that, based on a record of sales on the Internet, identifies a user who has purchased the particular product and the other product as a follower; an action analysis unit (13) that analyzes a record of purchase of the particular product and the other product by the follower; and an influence calculation unit (14) that calculates an influence of the particular action taken by the user using a result of the analysis on the record of purchase.

### TECHNICAL FIELD

The present invention relates to a determination device and a determination method for determining the influence of a user who serves as a lead user, and further to a computer-readable recording medium having recorded therein a program for realizing the same.

### BACKGROUND ART

In recent years, due to the diversity of users' preferences, products have become diverse in a wide variety of fields. However, there are still users who cannot be satisfied with existing products. Among such users, there are people who are called “lead users” (for example, see Patent Document 1). Lead users are users who fulfill their own needs by, for example, altering existing products by themselves to obtain products that suit their own needs.

In some cases, lead users have followers, i.e., users who intend to copy the actions of the lead users. The actions of the lead users are widely spread by these followers. Therefore, it is considered that finding of lead users and accurate determination of their influence are extremely useful for companies to develop new products and new markets.

Conventionally, finding of lead users and determination of their influence have been performed entirety by humans. For example, a person in charge discovers a user with distinctive actions as a lead user from articles posted on a blog and the like, and conducts an interview with the discovered lead user. The person in charge then determines the influence of that lead user from the result of the interview.

### CITATION LIST

### Patent Document

Patent Document 1: JP 2010-097576A (Page 2)

### DISCLOSURE OF THE INVENTION

### Problem to be Solved by the Invention

However, if the determination is made based on the result of the interview, a subjective view of an interviewer is easily relied upon, and it will be difficult to objectively and accurately determine the influence of the lead user.

One example of an object of the present invention is to provide a determination device, a determination method, and a computer-readable recording medium that can solve the above problem and objectively determine the influence of a lead user without depending on humans.

### Means for Solving the Problem

In order to achieve the above object, a determination device according to one aspect of the present invention includes: a product identification unit that discovers, from a document published on the Internet, a particular action taken by a user on a particular product, and identifies another product that has been used in the discovered particular action and is different from the particular product; a follower identification unit that, based on a record of sales on the Internet, identifies a user who has purchased the particular product and the other product as a follower; an action analysis unit that analyzes a record of purchase of the particular product and the other product by the follower; and an influence calculation unit that calculates an influence of the particular action taken by the user using a result of the analysis on the record of purchase.

In order to achieve the above object, a determination method according to one aspect of the present invention includes: (a) a step of discovering, from a document published on the Internet, a particular action taken by a user on a particular product, and identifying another product that has been used in the discovered particular action and is different from the particular product; (b) a step of, based on a record of sales on the Internet, identifying a user who has purchased the particular product and the other product as a follower; (c) a step of analyzing a record of purchase of the particular product and the other product by the follower; and (d) a step of calculating an influence of the particular action taken by the user using a result of the analysis on the record of purchase.

In order to achieve the above object, a computer-readable recording medium according to one aspect of the present invention has recorded therein a program including an instruction for causing a computer to execute: (a) a step of discovering, from a document published on the Internet, a particular action taken by a user on a particular product, and identifying another product that has been used in the discovered particular action and is different from the particular product; (b) a step of, based on a record of sales on the Internet, identifying a user who has purchased the particular product and the other product as a follower; (c) a step of analyzing a record of purchase of the particular product and the other product by the follower; and (d) a step of calculating an influence of the particular action taken by the user using a result of the analysis on the record of purchase.

### EFFECTS OF THE INVENTION

As described above, the present invention enables objective judgment about the influence of a lead user without depending on humans.

### BRIEF DESCRIPTION OF THE DRAWINGS

FIG. 1 is a block diagram showing a configuration of a determination device according to an embodiment of the present invention.

FIG. 2 is a flowchart showing the operations of the determination device according to the embodiment of the present invention.

FIG. 3 shows specific examples of a particular product and a particular action used in the embodiment of the present invention.

FIG. 4 is a block diagram showing an example of a computer that realizes the determination device according to the embodiment of the present invention.

### DESCRIPTION OF EMBODIMENTS

### Embodiment

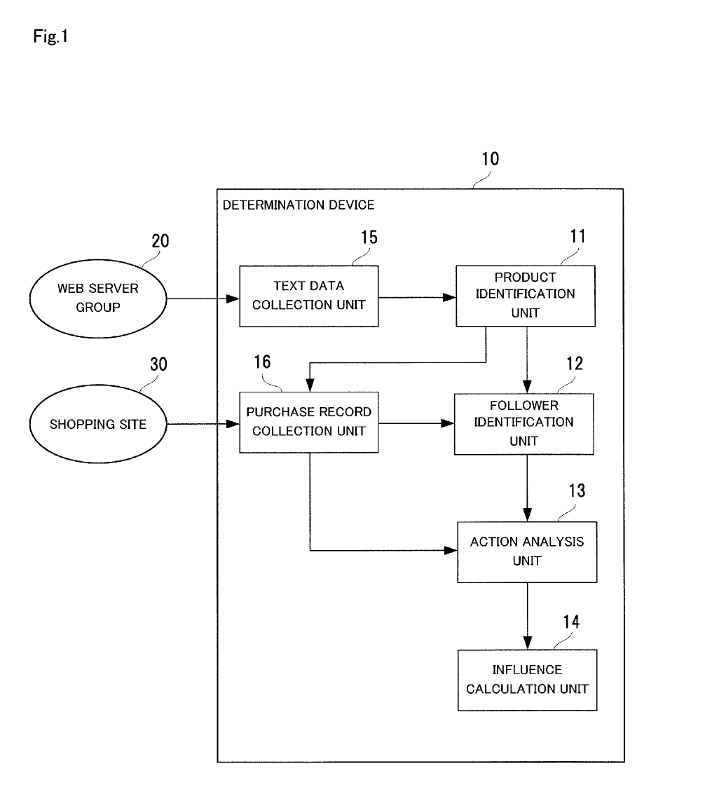

The following describes a determination device, a determination method, and a program according to an embodiment of the present invention with reference to FIGS. 1 to 4.

### Device Configuration

First, a configuration of the determination device according to the embodiment of the present invention will be described with reference to FIG. 1. FIG. 1 is a block diagram showing the configuration of the determination device according to the embodiment of the present invention.

A determination device 10 according to the present embodiment shown in FIG. 1 is a device for determining the influence of a user who serves as a lead user using information published on the Internet. As shown in FIG. 1, the determination device 10 includes a product identification unit 11, a follower identification unit 12, an action analysis unit 13, and an influence calculation unit 14.

Among these, the product identification unit 11 discovers, from documents published on the Internet, a particular action that a user took on a particular product, and identifies another product that was used in the discovered particular action and is different from the particular product.

Based on a record of sales on the Internet, the follower identification unit 12 identifies users who purchased the particular product and another product as followers. The action analysis unit 13 analyzes a record of purchase of the particular product and another product by the followers. The influence calculation unit 14 calculates the influence of the user's particular action using the result of analysis on the record of purchase.

In this way, the determination device 10 identifies a particular action taken by a certain user who has a possibility of becoming a lead user using information on the Internet, and further identifies followers of the particular action, without being influenced by subjective views of humans. The determination device 10 then calculates the influence of the particular action from a record of purchase by the identified followers. That is to say, the determination device 10 enables objective determination on the influence of the lead user without depending on humans.

The following is a more specific description of the configuration of the determination device 10 according to the present embodiment. First, as shown in FIG. 1, in the present embodiment, the determination device 10 includes a text data collection unit 15 and a purchase record collection unit 16 in addition to the product identification unit 11, the follower identification unit 12, the action analysis unit 13, and the influence calculation unit 14.

The text data collection unit 15 collects text data published on the Internet and a viewing record thereof from a Web server group 20 that exists on the Internet.

Specific sources of collection include blogs, microblogs as represented by Twitter, walls of an SNS (Social Networking Service), and the like.

However, the amount of text data published on the Internet is immense, and it is difficult to collect all text data and a viewing record thereof. For this reason, in the present embodiment, the text data collection unit 15 can also collect text data and a viewing record based on conditions designated by an administrator of the determination device 10. Conditions include a keyword (e.g., a name of a particular product), a time period of creation, a name of a server, a name of a service (e.g., an SNS (Social Networking Service)), and the like.

The purchase record collection unit 16 collects information related to sales of a particular product and another product on the Internet (hereinafter referred to as “sales information”). For example, in a case where access to a database of a shopping site 30 is permitted, the purchase record collection unit 16 accesses this database and collects information that identifies purchasers, quantities, time of purchase, and the like as the sales information of the particular product and another product. Access to the database is permitted, for example, when the determination device 10 and the shopping site 30 are managed by the same company, and when there is a certain relationship, such as a capital relationship and a contract relationship, between a company that manages the determination device 10 and a company that manages the shopping site 30.

The purchase record collection unit 16 may also perform the collection by receiving the sales information provided by the purchasers themselves. It should be noted that, in the present embodiment, no particular limitation is placed on a mechanism of receiving the sales information provided by the purchasers themselves.

In the present embodiment, the product identification unit 11 discovers, from the text data collected by the text data collection unit 15, a particular action that was taken by a user (hereinafter referred to as a “lead user candidate”) on the particular product. Specifically, the product identification unit 11 discovers the particular action by identifying, from the collected text data, an article about a modification that the lead user candidate made to the particular product using another product that is different from the particular product. Hereinafter, “another product” will be referred to as a “product for modification”.

One example of techniques to discover a modification from blogs and the like is a template matching technique. With the template matching technique, for example, templates such as “. . . had a problem of . . . , but a combination with . . . worked” and “. . . of . . . did not work, but was fixed by changing it to . . . ” are compared with text data of blogs and the like. Cases that match the modification are discovered from the result of comparison.

In identifying the matching cases, the match need not be a complete match, and the judgment may be made in a state where ambiguity remains. The judgment about the match may be made after execution of morphological analysis and syntactic analysis based on the result of the analyses.

A modification can be discovered also by searching the text data of blogs and the like with use of a keyword that is involved in a modification and set on a field-by-field basis. For example, in the field of automobiles, modification is referred to as “tune up” or “customizing”. It is therefore considered that, with use of these keywords, a modification related to automobiles can be discovered. In addition, it is considered that a modification can be discovered also by presetting a list of names of products involved in a modification and conducting a search with use of the set list.

In the present embodiment, the follower identification unit 12 identifies, from the sales information collected by the purchase record collection unit 16, users who purchased the particular product and the product for modification, that is to say, users who have a possibility of becoming followers (hereinafter referred to as “follower candidates”). Then, the follower identification unit 12 determines whether or not these identified follower candidates have viewed an article about the modification identified by the product identification unit 11, and identifies these follower candidates as followers if they have viewed the article.

It should be noted that whether or not the identified follower candidates have viewed the article about the modification can be determined by, for example, checking whether or not the viewing record collected by the text data collection unit 15 includes identifiers with which the identified follower candidates can be identified, e.g., user addresses, IP addresses, and the like.

As described above, in the present embodiment, the action analysis unit 13 analyzes the record of purchase of the particular product and the product for modification by the followers. Frequencies of purchase of the particular product and the product for modification, as well as changes in the frequencies of purchase, are identified through this analysis on the record of purchase.

In the present embodiment, the influence calculation unit 14 first determines whether or not the identified frequencies of purchase and changes therein satisfy a set standard. If the result of determination indicates that the set standard is satisfied, the influence calculation unit 14 sets a target lead user candidate as a lead user, and calculates the influence of the particular action taken by this lead user using a total purchase price of the product for modification purchased by the followers.

Specific examples of the foregoing set standard include “every week during one month, two or more purchasers of the particular product purchased the product for modification”, and “every week during the first month, five or more purchasers of the particular product purchased the product for modification, and every week during the following six months, three or more purchasers of the particular product purchased the product for modification”.

The influence calculation unit 14 may also, for example, divide the total purchase price of the product for modification purchased by the followers by the number of members of an SNS community to which the identified followers belong (the size of the community), and use the obtained quotient as the influence. The influence thus obtained is normalized so as not to be constrained by the community size. Therefore, it can be judged that the larger the value of the influence, the larger the influence of the lead user. Also, such normalization based on the size of the community is effective especially in obtaining the influence of the lead user in the community.

It should be noted that the size of the community may or may not be published by an operator of the community. In the latter case, the size of the community can be estimated by random sampling. Specifically, the community size can be estimated by selecting arbitrary people and identifying whether or not they are members of the community through a preliminary interview and the like.

In the present embodiment, the influence of the particular action taken by the lead user may be calculated using a method other than the methods described above. It is sufficient for the influence calculation unit 14 to calculate the influence based on the result of analysis on the record of purchase, such as the number of the followers, the price paid by all followers or on a per-follower basis, and a time period between when the followers viewed the article about the particular action and when the followers purchased the particular product or the product for modification.

Also, the influence of the lead user calculated by the influence calculation unit 14 need not be limited to the “influence of the lead user in the community”, and may be the “influence of the lead user in the entire society”.

The above-described purchase record collection unit 16 can further collect user reviews about purchased products as the sales information. In this case, the influence calculation unit 14 can determine whether or not the collected reviews include positive comments by the followers on the modification, and make the result of determination affect the calculation of the influence. For example, the influence calculation unit 14 increases the value of the calculated influence if the number of positive comments is equal to or larger than a set value, and reduces the value of the calculated influence if the number of positive comments is smaller than the set value.

### Device Operations

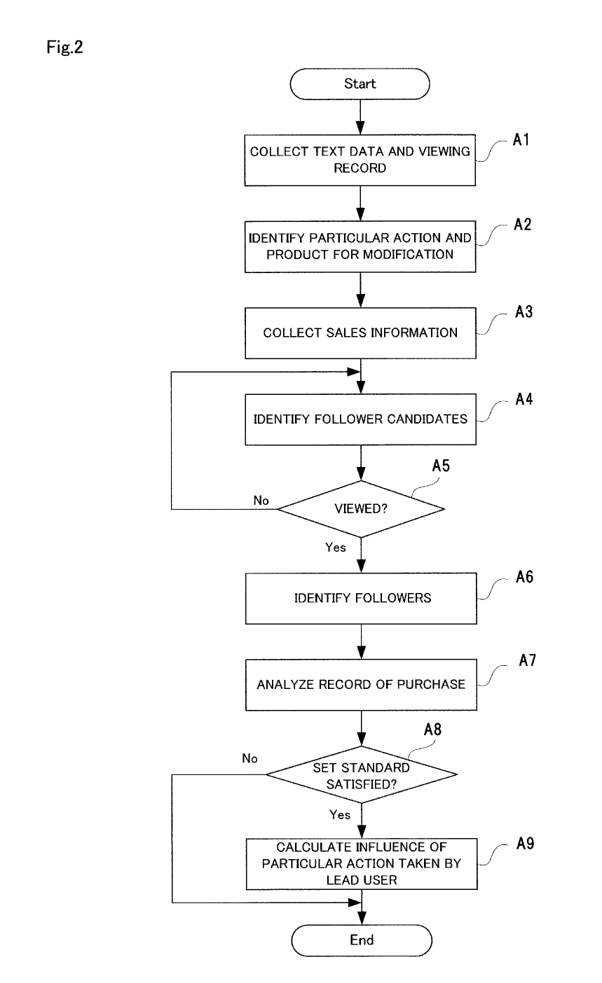

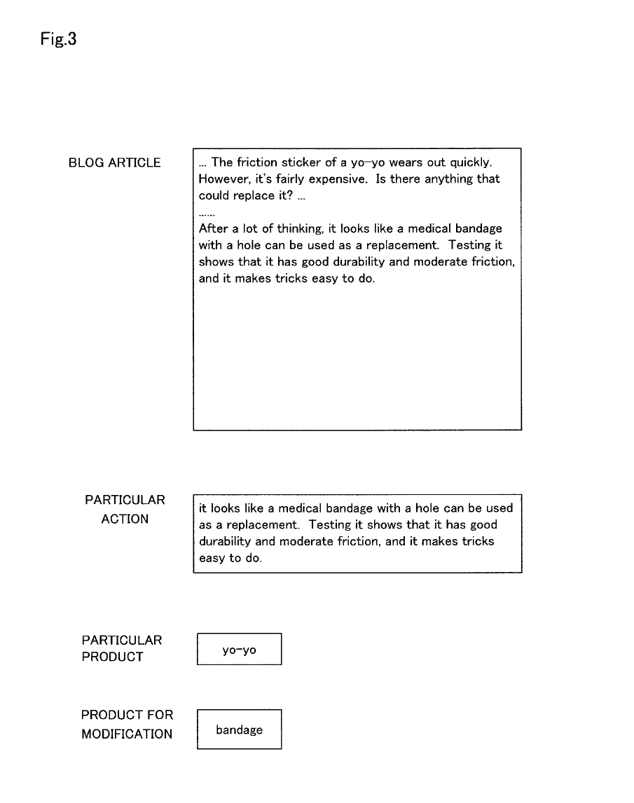

A description is now given of the operations of the determination device 10 according to the embodiment of the present invention with reference to FIGS. 2 and 3. FIG. 2 is a flowchart showing the operations of the determination device according to the embodiment of the present invention. FIG. 3 shows specific examples of the particular product and particular action used in the embodiment of the present invention. In the following description, FIG. 1 will be referred to as appropriate. Also, in the present embodiment, the determination method is implemented by causing the determination device 10 to operate. Therefore, the following description of the operations of the determination device 10 applies to the determination method according to the present embodiment.

As shown in FIG. 2, first, the text data collection unit 15 collects, from the Web server group 20, text data published on the Internet and a viewing record thereof (step A1).

Specifically, in step A1, the administrator of the determination device 10 inputs a name of a particular product and a time period of creation, and the collection is performed based thereon. For example, if “yo-yo” and “past one month” are input respectively as the name of the particular product and the time period of creation, a blog article written by a lead user candidate about a yo-yo and a viewing record thereof are collected as shown in FIG. 3.

Next, the product identification unit 11 discovers, from the text data collected in step A1, a particular action taken by the lead user candidate on the particular product, and further identifies a product for modification used in the discovered particular action (step A2).

Specifically, in step A2, the product identification unit 11 first identifies, from the blog article, an article about a modification that the lead user candidate made to a yo-yo using a product for modification different from a yo-yo, as shown in FIG. 3. Then, the product identification unit 11 identifies “bandage” used in the identified article as the product for modification.

Next, the purchase record collection unit 16 collects information related to sales of the particular product and the product for modification on the Internet (sales information) (step A3). Specifically, in step A3, the purchase record collection unit 16, for example, accesses the database of the shopping site 30 that is permitted to be accessed, and then collects information that identifies purchasers, quantities, time of purchase, and the like of “yo-yo” and “bandage”.

Next, the follower identification unit 12 identifies follower candidates who purchased the particular product and the product for modification from the sales information collected in step A3 (step A4). Specifically, in step A4, the follower identification unit 12 identifies purchasers who purchased “yo-yo” and “bandage” together from a record of sales as the follower candidates. In this case, “yo-yo” and “bandage” are not limited to being purchased at the same time, and a time lag may exist between the purchase of “yo-yo” and the purchase of “bandage”. No particular limitation is placed on the extent of the time lag. The time lag may be, for example, a week or less.

Next, based on the viewing record collected in step A1, the follower identification unit 12 determines whether or not the follower candidates identified in step A4 have viewed the article about the particular action (modification) identified in step A2 (step A5). Specifically, in step A5, the follower identification unit 12 determines whether or not the viewing record collected in step A1 includes identifiers (e.g., user IDs and IP addresses) of the follower candidates identified in step A4.

If the result of determination in step A5 indicates that the follower candidates have not viewed the article, the follower identification unit 12 executes step A4 again. On the other hand, if the result of determination in step A5 indicates that the follower candidates have viewed the article, the follower identification unit 12 identifies the follower candidates identified in step A4 as followers (step A6).

Next, once the followers have been identified, the action analysis unit 13 analyzes a record of purchase of the particular product, “yo-yo”, and the product for modification, “bandage”, by the identified followers using the sales information collected in step A3, and identifies frequencies of purchase of these products as well as changes in the frequencies of purchase (step A7).

Next, the influence calculation unit 14 determines whether or not the frequencies of purchase and the changes therein identified in step A7 satisfy a set standard (step A8). If the result of determination in step A8 indicates that the set standard is not satisfied, the influence calculation unit 14 ends processing. On the other hand, if the result of determination in step A8 indicates that the set standard is satisfied, the influence calculation unit 14 calculates the influence of the user's particular action using the result of step A7 (step A9).

Specifically, in step A9, the influence calculation unit 14, for example, identifies an SNS community to which the followers identified in step A6 belong, and further obtains or estimates the number of members of the identified community (the size of the community). Then, the influence calculation unit 14 divides a total purchase price of “bandage” purchased by the followers by the identified number of members, and uses the obtained quotient as the influence.

Once the above-described steps A1 to A9 have been executed, processing of the determination device 10 is ended. Thereafter, if the administrator of the determination device 10 newly inputs a name of a particular product and a time period of creation, steps A1 to A9 are executed again.

In the present embodiment, the following steps may be executed in place of steps A4 to A6. First, after the execution of step A3, the follower identification unit 12 identifies purchasers of the product for modification from the sales information collected in step A3, and determines whether or not the purchasers have viewed the article about the particular action using the viewing record collected in step A1. If it is determined that the article has been viewed, the follower identification unit 12 determines whether or not a difference between a date/time when the purchasers viewed the article and a date/time when the purchasers purchased the product for modification falls within a set time period, and identifies the purchasers as followers if the difference falls within the set time period.

As described above, in the present embodiment, a modification and a product for modification associated with a particular product are identified from data on the Internet without relying upon subjective views of humans, and followers are identified based on the identified modification and product for modification. Also, a numeric value indicating the influence of a lead user is calculated from a record of purchase of the product for modification by the followers. That is to say, the present embodiment enables objective determination on the influence of the lead user without depending on humans.

### Program

It is sufficient for the program according to the embodiment of the present invention to cause a computer to execute steps A1 to A9 shown in FIG. 3. The determination device 10 and the determination method according to the present embodiment can be realized by installing this program in the computer and executing the installed program. In this case, a CPU (Central Processing Unit) of the computer functions as the product identification unit 11, the follower identification unit 12, the action analysis unit 13, the influence calculation unit 14, the text data collection unit 15, and the purchase record collection unit 16, and executes processing accordingly.

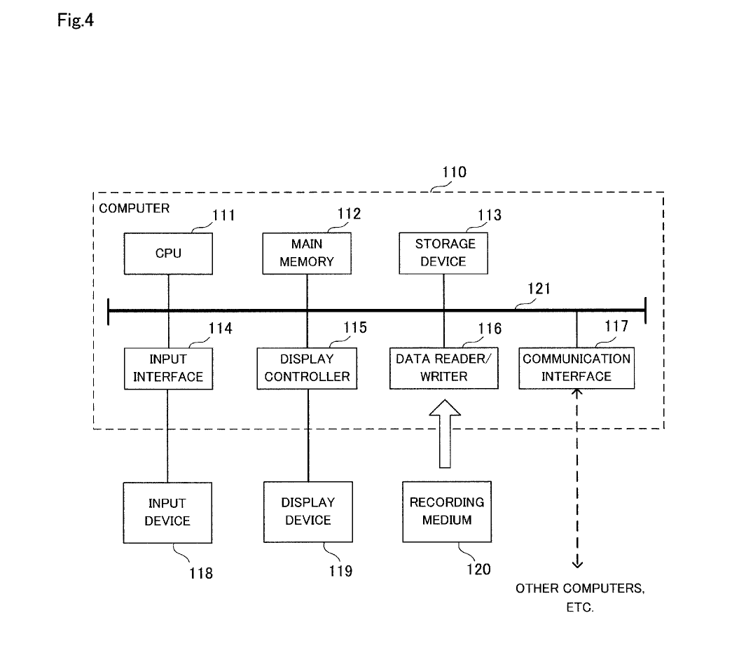

A description is now given of a computer that realizes the determination device 10 by executing the program according to the present embodiment with reference to FIG. 4. FIG. 4 is a block diagram showing an example of a computer that realizes the determination device according to the embodiment of the present invention.

As shown in FIG. 4, a computer 110 includes a CPU 111, a main memory 112, a storage device 113, an input interface 114, a display controller 115, a data reader/writer 116, and a communication interface 117. These components are connected in such a manner that they can perform data communication with one another via a bus 121.

The CPU 111 executes various types of operations by deploying programs (codes) according to the present embodiment stored in the storage device 113 to the main memory 112, and executing the deployed programs in a predetermined order. The main memory 112 is typically a volatile storage device such as a DRAM (Dynamic Random Access Memory). The programs according to the present embodiment are provided while being stored in a computer-readable recording medium 120. It should be noted that the programs according to the present embodiment may be distributed over the Internet connected via the communication interface 117.

Specific examples of the storage device 113 include a hard disk drive and a semiconductor storage device such as a flash memory. The input interface 114 mediates data transmission between the CPU 111 and an input device 118 such as a keyboard and a mouse. The display controller 115 is connected to a display device 119 and controls display on the display device 119.

The data reader/writer 116 mediates data transmission between the CPU 111 and the recording medium 120. The data reader/writer 116 reads the programs from the recording medium 120, and writes the result of processing in the computer 110 into the recording medium 120. The communication interface 117 mediates data transmission between the CPU 111 and other computers.

Specific examples of the recording medium 120 include a general-purpose semiconductor storage device such as a CF (Compact Flash, registered trademark) and an SD (Secure Digital), a magnetic storage medium such as a flexible disk, and an optical storage medium such as a CD-ROM (Compact Disc Read Only Memory).

A part or an entirety of the above embodiment can be described as, but is not limited to, the following Notes 1 to 12.

### (Note 1)

A determination device including: a product identification unit that discovers, from a document published on the Internet, a particular action taken by a user on a particular product, and identifies another product that has been used in the discovered particular action and is different from the particular product; a follower identification unit that, based on a record of sales on the Internet, identifies a user who has purchased the particular product and the other product as a follower; an action analysis unit that analyzes a record of purchase of the particular product and the other product by the follower; and an influence calculation unit that calculates an influence of the particular action taken by the user using a result of the analysis on the record of purchase.

### (Note 2)

The determination device according to note 1, wherein the product identification unit discovers the particular action by identifying, on the Internet, an article about a modification that the user has made to the particular product using the other product.

### (Note 3)

The determination device according to note 2, wherein the follower identification unit identifies the follower further on a condition that the follower has viewed the article.

### (Note 4)

The determination device according to note 3, wherein through the analysis on the record of purchase, the action analysis unit identifies frequencies of purchase of the particular product and the other product, as well as changes in the frequencies of purchase, and if the identified frequencies of purchase and changes therein satisfy a set standard, the influence calculation unit calculates the influence of the particular action taken by the user using a total purchase price of the other product purchased by the follower.

### (Note 5)

A determination method including: (a) a step of discovering, from a document published on the Internet, a particular action taken by a user on a particular product, and identifying another product that has been used in the discovered particular action and is different from the particular product; (b) a step of, based on a record of sales on the Internet, identifying a user who has purchased the particular product and the other product as a follower; (c) a step of analyzing a record of purchase of the particular product and the other product by the follower; and (d) a step of calculating an influence of the particular action taken by the user using a result of the analysis on the record of purchase.

### (Note 6)

The determination method according to note 5, wherein in step (a), the particular action is discovered by identifying, on the Internet, an article about a modification that the user has made to the particular product using the other product.

### (Note 7)

The determination method according to note 6, wherein in step (b), the follower is identified further on a condition that the follower has viewed the article.

### (Note 8)

The determination method according to note 7, wherein in step (c), frequencies of purchase of the particular product and the other product, as well as changes in the frequencies of purchase, are identified through the analysis on the record of purchase, and in step (d), if the identified frequencies of purchase and changes therein satisfy a set standard, the influence of the particular action taken by the user is calculated using a total purchase price of the other product purchased by the follower.

### (Note 9)

A computer-readable recording medium having recorded therein a program including an instruction for causing a computer to execute: (a) a step of discovering, from a document published on the Internet, a particular action taken by a user on a particular product, and identifying another product that has been used in the discovered particular action and is different from the particular product; (b) a step of, based on a record of sales on the Internet, identifying a user who has purchased the particular product and the other product as a follower; (c) a step of analyzing a record of purchase of the particular product and the other product by the follower; and (d) a step of calculating an influence of the particular action taken by the user using a result of the analysis on the record of purchase.

### (Note 10)

The computer-readable recording medium according to note 9, wherein in step (a), the particular action is discovered by identifying, on the Internet, an article about a modification that the user has made to the particular product using the other product.

### (Note 11)

The computer-readable recording medium according to note 10, wherein in step (b), the follower is identified further on a condition that the follower has viewed the article.

### (Note 12)

The computer-readable recording medium according to note 11, wherein in step (c), frequencies of purchase of the particular product and the other product, as well as changes in the frequencies of purchase, are identified through the analysis on the record of purchase, and in step (d), if the identified frequencies of purchase and changes therein satisfy a set standard, the influence of the particular action taken by the user is calculated using a total purchase price of the other product purchased by the follower.

While the invention of the present application has been described with reference to the above embodiment, the invention of the present application is by no means limited to the above embodiment. The configurations and details of the invention of the present application may be subject to various changes that can be understood by a person skilled in the art within a scope of the invention of the present application.

The present application claims the benefit of priority from Japanese Patent Application No. 2012-214218, filed Sep. 27, 2012, the disclosure of which is incorporated herein by reference in its entirety.

### INDUSTRIAL APPLICABILITY

As described above, the present invention enables objective judgment about the influence of a lead user without depending on humans. The present invention is useful especially in the field of marketing.

### LIST OF REFERENCE NUMERALS

10 determination device

11 product identification unit

12 follower identification unit

13 action analysis unit

14 influence calculation unit

15 text data collection unit

16 purchase record collection unit

20 Web server group

30 shopping site

110 computer

111 CPU

112 main memory

113 storage device

114 input interface

115 display controller

116 data reader/writer

117 communication interface

118 input device

119 display device

120 recording medium

121 bus

What is claimed is:

1. A determination device comprising:
a product identification unit that discovers, from a document published on the Internet, a particular action taken by a user on a particular product, and identifies another product that has been used in the discovered particular action and is different from the particular product;
a follower identification unit that, based on a record of sales on the Internet, identifies a user who has purchased the particular product and the other product as a follower;
an action analysis unit that analyzes a record of purchase of the particular product and the other product by the follower; and
an influence calculation unit that calculates an influence of the particular action taken by the user using a result of the analysis on the record of purchase.

2. The determination device according to claim 1, wherein
the product identification unit discovers the particular action by identifying, on the Internet, an article about a modification that the user has made to the particular product using the other product.

3. The determination device according to claim 2, wherein
the follower identification unit identifies the follower further on a condition that the follower has viewed the article.

4. The determination device according to claim 1, wherein
through the analysis on the record of purchase, the action analysis unit identifies frequencies of purchase of the particular product and the other product, as well as changes in the frequencies of purchase, and
if the identified frequencies of purchase and changes therein satisfy a set standard, the influence calculation unit calculates the influence of the particular action taken by the user using a total purchase price of the other product purchased by the follower.

5. A determination method comprising:
(a) a step of discovering, from a document published on the Internet, a particular action taken by a user on a particular product, and identifying another product that has been used in the discovered particular action and is different from the particular product;
(b) a step of, based on a record of sales on the Internet, identifying a user who has purchased the particular product and the other product as a follower;
(c) a step of analyzing a record of purchase of the particular product and the other product by the follower; and
(d) a step of calculating an influence of the particular action taken by the user using a result of the analysis on the record of purchase.

6. The determination method according to claim 5, wherein
in step (a), the particular action is discovered by identifying, on the Internet, an article about a modification that the user has made to the particular product using the other product.

7. The determination method according to claim 6, wherein
in step (b), the follower is identified further on a condition that the follower has viewed the article.

8. The determination method according to claim 5, wherein
in step (c), frequencies of purchase of the particular product and the other product, as well as changes in the frequencies of purchase, are identified through the analysis on the record of purchase, and
in step (d), if the identified frequencies of purchase and changes therein satisfy a set standard, the influence of the particular action taken by the user is calculated using a total purchase price of the other product purchased by the follower.

9. A computer-readable recording medium having recorded therein a program including an instruction for causing a computer to execute:
(a) a step of discovering, from a document published on the Internet, a particular action taken by a user on a particular product, and identifying another product that has been used in the discovered particular action and is different from the particular product;
(b) a step of, based on a record of sales on the Internet, identifying a user who has purchased the particular product and the other product as a follower;
(c) a step of analyzing a record of purchase of the particular product and the other product by the follower; and
(d) a step of calculating an influence of the particular action taken by the user using a result of the analysis on the record of purchase.

10. The computer-readable recording medium according to claim 9, wherein
in step (a), the particular action is discovered by identifying, on the Internet, an article about a modification that the user has made to the particular product using the other product.

11. The computer-readable recording medium according to claim 10, wherein
in step (b), the follower is identified further on a condition that the follower has viewed the article.

12. The computer-readable recording medium according to claim 9, wherein
in step (c), frequencies of purchase of the particular product and the other product, as well as changes in the frequencies of purchase, are identified through the analysis on the record of purchase, and
in step (d), if the identified frequencies of purchase and changes therein satisfy a set standard, the influence of the particular action taken by the user is calculated using a total purchase price of the other product purchased by the follower.
